(19) United States
(12) Patent Application Publication
(10) Pub. No.: US 2013/0020928 A1
(43) Pub. Date: Jan. 24, 2013

(54) PHOSPHOR PRECURSOR COMPOSITION

(71) Applicants: Alok Mani Srivastava, Niskayuna, NY (US); Holly Ann Comanzo, Niskayuna, NY (US); William Winder Beers, Chesterland, OH (US)

(72) Inventors: Alok Mani Srivastava, Niskayuna, NY (US); Holly Ann Comanzo, Niskayuna, NY (US); William Winder Beers, Chesterland, OH (US)

(73) Assignee: GENERAL ELECTRIC COMPANY, SCHENECTADY, NY (US)

(21) Appl. No.: 13/184,773

(22) Filed: Jul. 18, 2011

(51) Int. Cl. H01J 1/63; C09K 11/55; H01J 1/62; C09K 11/80

(52) U.S. Cl. 313/486; 252/301.4 R; 313/483

(57) ABSTRACT

In accordance with one aspect of the present invention, a phosphor precursor composition is provided. The phosphor precursor composition includes gamma alumina, strontium oxide precursor, europium oxide precursor, and an alkaline earth metal precursor other than strontium oxide precursor which affords a phosphor having a formula selected from the group consisting of Sr₄Al₁₄O₂₅:Eu²⁺, Sr_{4-a-z}AₐEU_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0. Another aspect of the present invention provides a phosphor composition. Also provided in another aspect of the invention is a method of making the phosphor and a lighting apparatus including the phosphor.

### BACKGROUND

The invention generally relates to a phosphor. More particularly, the invention relates to a strontium aluminum phosphor composition and a method for making the core-shell phosphor.

A phosphor is a luminescent material that absorbs radiation energy in a portion of the electromagnetic spectrum and emits energy in another portion of the electromagnetic spectrum. Phosphors of one important class are crystalline inorganic compounds of very high chemical purity and of controlled composition to which small quantities of other elements (called “activators”) have been added to convert them into efficient fluorescent materials. With the right combination of activators and inorganic compounds, the color of the emission can be controlled. Most useful and well-known phosphors emit radiation in the visible portion of the electromagnetic spectrum in response to excitation by electromagnetic radiation outside the visible range.

Aluminate phosphors such as strontium aluminate (SAE) are widely used as a component of the phosphor blends in most fluorescent lamps intended for white light generation. These phosphors may contain various activator ions, which impart the phosphor property. For example, a divalent europium (Eu²⁺) activated phosphor absorbs ultraviolet (UV) emission (i.e., exciting radiation) from the mercury plasma in a fluorescent lamp and emits blue visible light. Despite its wide use, these phosphors suffer from poor efficacy and lumen maintenance, specifically under high wall load conditions, which is usually found in compact fluorescent lamps (CFLs), and some small diameter linear fluorescent lamps. Efficacy is the luminosity per unit of input electric power (measured in units of lumens/watt). Lumen maintenance is the ability of the phosphor to resist radiation damage over time is notorious for its shortcomings in brightness and maintenance, particularly in those applications involving exposure to high ultraviolet (UV) and vacuum ultraviolet (VUV) fluxes.

The poor lumen maintenance in aluminate phosphors can be caused by UV (185 nm and 254 nm)-induced absorption centers (also referred to as “color centers”) and other lattice defects. “Color centers” are caused by lattice defects that trap an electron or a hole, which are created by exciting radiation whose energy are higher than the band gap of the material. It has been established that in many fluorescent lamp phosphors, the color centers are created by the 185 nm radiation emitted by the mercury plasma and this radiation can excite the phosphor across the band gap. The electron (in the conduction band) or a hole (in valence band) may be trapped by a defect, called color center, in the crystal lattice of the phosphor. The color centers induce absorption of the exciting radiation anywhere from the deep UV to the infrared region of the spectrum. Thus, these centers can degrade phosphor brightness by either absorbing the visible emission emitted by the phosphor or by absorbing a part of the 254 nm mercury exciting radiation.

Therefore, there is a need for an aluminate phosphor with an improved efficiency and lumen maintenance.

### BRIEF DESCRIPTION

In accordance with one aspect of the present invention, a phosphor precursor composition is provided. The phosphor precursor composition includes gamma alumina, strontium oxide precursor, europium oxide precursor, and an alkaline earth metal precursor other than strontium oxide precursor which affords a phosphor having a formula selected from the group consisting of Sr₄Al₁₄O₂₅:Eu²⁺, Sr_{4-a-z}AₐEU_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0.

In accordance with another aspect, the present invention provides a phosphor precursor composition comprising gamma alumina, strontium carbonate, europium oxide, and an alkaline earth metal carbonate other than strontium carbonate which affords a phosphor having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0.

In accordance with one aspect of the present invention, a phosphor composition is provided. The phosphor composition has a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 1000° C., wherein A is an alkaline earth metal other than strontium, 0≦a<4; 0.001<z<0.3; and 4-a-z>0; and wherein at least a portion of the aluminum present in the phosphor composition is derived from gamma aluminum oxide.

In accordance with yet another aspect, the present invention provides a method of making a phosphor composition. The method includes mixing a gamma aluminum oxide, and containing compound of europium and at least one material selected from the group consisting of lithium tetraborate, lithium carbonate, boric acid, borax, alkali borate salts, and combinations thereof to form a reaction mixture; heating the reaction mixture in a reducing atmosphere at a temperature in a range from about 800° C. to about 1300° C. for a time sufficient to form the phosphor composition having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0; and wherein at least a portion of the aluminum present in the phosphor composition is derived from gamma aluminum oxide.

In accordance with another aspect, the present invention provides a lighting apparatus that includes (i) a source of radiation; and (ii) a phosphor radiationally coupled to the source of radiation, and having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 1000° C., wherein A is an alkaline earth metal other than strontium, 0≦a<4; 0.001<z<0.3; and 4-a-z>0; and wherein at least a portion of the aluminum present in the phosphor composition is derived from gamma aluminum oxide.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the term “phosphor” or “phosphor material” may be used to denote both a single phosphor composition as well as a blend of two or more phosphors compositions. In some embodiments, the phosphor contains a blend of blue, red, yellow, orange and green phosphors. The blue, red, yellow, orange and green phosphors are so called or known after the color of their light emission.

As discussed in detail below, embodiments of the present invention include a phosphor precursor composition is provided which includes gamma alumina, strontium oxide precursor, europium oxide precursor, and an alkaline earth metal oxide precursor other than strontium oxide precursor which affords a phosphor having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0.

Typically, the phosphor precursor composition includes an oxide precursor compound. As used herein an “oxide precursor” is defined as an oxygen containing compound that can decompose to form oxides. Non-limiting examples of oxide precursor compounds include carbonates, nitrates, nitrides, sulfates, chlorates, perchlorates, oxyhalides, acetates, citrates, salt of organic acids (example carboxylates) and combinations thereof. In one embodiment, the strontium oxide precursor, europium oxide precursor may include at least one selected from the group consisting of the corresponding carbonate compound, hydroxide compound, the corresponding elemental oxide compound and combinations thereof. In one embodiment, the strontium oxide precursor may include a strontium carbonate. In yet another embodiment, the europium oxide precursor may include a europium carbonate.

The phosphor precursor composition includes an alkaline earth metal oxide precursor other than the strontium oxide precursor. In various embodiments, the alkaline earth metal oxide precursor is at least one selected from the group consisting of calcium oxide precursor, barium oxide precursor, magnesium oxide precursor, zinc oxide precursor, and combinations thereof. In one embodiment, the alkaline earth metal oxide precursor is calcium oxide precursor. In another embodiment, the alkaline earth metal oxide precursor is barium oxide precursor.

In some embodiments, the phosphor precursor composition may further include a rare earth metal oxide. In one embodiment, the rare earth metal oxide is selected from the group consisting of samarium oxide, ytterbium oxide, thulium oxide, cerium oxide, terbium oxide, praseodymium oxide and combinations thereof. In another embodiment, the rare earth metal oxide is selected from the group consisting of cerium oxide, terbium oxide, praseodymium oxide and combinations thereof.

The phosphor precursor composition of the present invention affords a phosphor having a formula selected from the group consisting of Sr₄Al₁₄O₂₅:Eu²⁺, Sr_{4-a-z}Aₐ Eu_{z}D₁₂O₂₂, Sr_{4-a-z}AₐEu_{z}D₁₄O₂₅, and combinations thereof upon thermal treatment at a temperature above 800° C., wherein 0≦a<4; 0.001<z<0.3; and 4-a-z>0.

In one embodiment, the phosphor composition has a formula Sr₄Al₁₄O₂₅:Eu²⁺. In another embodiment, the phosphor composition has a formula (Sr,Ca,Ba)₄Al₁₄O₂₅:Eu²⁺. In one embodiment, the phosphor composition has a formula selected from the group consisting of Sr_{3.899}Eu_{0.10}Al₁₄O₂₅, Sr_{3.1}Ba_{0.2}Ca_{0.6}EU_{0.10}Al₁₄O₂₅, Sr_{2.5}Ba_{0.6}Ca_{0.8}EU_{0.10}Al₁₄O₂₅, Sr_{1.9}BaCaEu_{0.10}Al₁₄O₂₅, Sr_{3.899}EU_{0.10}Ce_{0.001}Al₁₄O₂₅, Sr_{3.899}Eu_{0.10}Pr_{0.001}Al₁₄O₂₅, Sr_{3.899}Eu_{0.10}Ce_{0.001}Al₁₄O₂₅, and Sr_{3.8}Eu_{0.10}Tb_{0.001}Al₁₄O₂₅.

In one embodiment, the phosphor composition further comprises a trivalent rare earth ion. The trivalent rare earth ion is selected from the group consisting of samarium, ytterbium, thulium, cerium, terbium, praseodymium and combinations thereof. In another embodiment, the phosphor composition has a formula Sr₄Al₁₄O₂₅:Eu²⁺,Q³⁺, wherein Q³⁺ is a trivalent rare earth ion. The efficacy and lumen maintenance of the phosphor composition may be improved by the presence of the trivalent rare earth ions, which preferentially trap the charge carriers generated by a damaging component of the exciting radiation. The rare earth ions usually have a higher charge carrier (i.e., electron and/or hole) capture cross section than the lattice defects, and thus act as alternative charge carrier (electron or hole) trapping centers to the lattice defects. These alternative charge carrier trapping centers improve the phosphor efficacy and lumen maintenance by preventing a large number of charge carriers from reaching the lattice defects and forming color centers or other defects which negatively impact on the phosphor efficacy and lumen maintenance. Thus, the rare earth ions decrease the number of color centers or other defects that negatively impact on the phosphor efficacy and lumen maintenance. Typically, the function of the trivalent rare earth ion is to trap charge carriers in a host lattice or material preferentially to the defects. However, the trivalent rare earth ions may perform other intended functions in the phosphor, as desired.

In one embodiment, the phosphor composition may include one or more rare earth ions which may exist in stable multi-valence states, such as divalent and trivalent states or trivalent and tetravalent states. For example, the phosphor composition containing the trivalent rare earth ions may also exhibit a stable divalent valence state in the composition. Depending on their stable valence states, the rare earth ion may provide an electron-trapping center or a hole-trapping center and may also be referred to as an “electron trapping dopant ion” or a “hole trapping dopant ion,” respectively. In one embodiment, the trivalent rare earth ion may be selected from the group consisting of Ce³⁺, Tb³⁺ and Pr³⁺. In another embodiment, the trivalent rare earth ion is Pr³⁺. In yet another embodiment, the trivalent rare earth ion is Ce³⁺.

In one embodiment, the trivalent rare earth ions in the phosphor composition is in a range from about 10 ppm (parts per million) to about 10,000 ppm. In certain embodiments, the concentration of rare earth ion may vary between about 2500 ppm to about 7,000 ppm. In another embodiment, trivalent rare earth ions in the phosphor composition is in a range from about 10 ppm (parts per million) to about 2000 ppm. In one embodiment, the europium ion is present in a range from about 1 mole % to about 50 mole % of the total weight of the composition. In another embodiment, the trivalent rare earth ions in the phosphor composition is in a range from about 0.001 mole percent to about 1 mole percent of the trivalent rare earth ion.

In one embodiment, the phosphor composition of the present invention further include one or more additional phosphors, such as a blend of phosphors may be used in the lighting apparatus. Non-limiting examples of the additional phosphors include as green, red, orange, yellow and blue emitting phosphors that may be used to provide a white light. Furthermore, some other phosphors may be used, e.g., those emitting throughout the visible spectrum region, at wavelengths substantially different from those of the phosphors described herein. These additional phosphors may be used in the blend to customize the white color of the resulting light, and to produce sources with improved light quality.

When the phosphor material includes a blend of two or more phosphors, the ratio of each of the individual phosphors in the phosphor blend may vary, depending on the characteristics of the desired light output. The relative proportions of the individual phosphors in the various phosphor blends may be adjusted, so that when their emissions are blended and employed in a lighting device, there is produced visible light of predetermined x and y values on the CIE (International Commission on Illumination) chromaticity diagram. As stated, a white light is preferably produced. As stated, however, the exact identity and amounts of each phosphor in the phosphor composition can be varied according to the needs of the end user.

In one embodiment, the phosphor compositing may contain optically inert trace impurities. In one embodiment, the presence of such impurities in an amount up to about 10% by weight of the phosphor composition and will not significantly affect the quantum efficiency or color of the phosphor.

Typically, it may be desirable to add pigments or filters to the phosphor composition. In one embodiment, the phosphor composition includes from about 0% to about 5% by weight (based on the total weight of the phosphors) of a pigment or other UV absorbent material capable of absorbing UV radiation having a wavelength between 250 nm and 450 nm. Suitable pigments or filters include any of those known in the art that are capable of absorbing radiation generated between 250 nm and 450 nm. Such pigments include, for example, nickel titanate or praseodymium zirconate.

In one embodiment, the phosphor composition may be used in a lighting apparatus such as a LED. In another embodiment, the phosphor composition described above may be used in additional applications besides LEDs. For example, the material may be used as a phosphor in a fluorescent lamp, in a cathode ray tube, in a plasma display device, in a backlighting liquid crystal system, in a xenon excitation lamp, in a device for excitation by light-emitting diodes (LEDs), in a cathode ray tubes, in a UV excitation device, such as a chromatic lamp or in a liquid crystal display (LCD). The material may also be used as a scintillator in an electromagnetic calorimeter, in a gamma ray camera, in a computed tomography scanner or in a laser. These uses are meant to be merely exemplary and not exhaustive.

In accordance with another aspect, the present invention provides a lighting apparatus that includes (i) a source of radiation; and (ii) a phosphor radiationally coupled to the source of radiation, and having a formula selected from the group consisting of Sr_{4-a-z}Aₐ Eu_{z}D₁₂O₂₂ and Sr_{4-a-z}AₐEu_{z}D₁₄O₂₅; wherein A is an at least two alkaline-earth metal other than strontium; D is aluminum; 0≦a<4; 0.001<z<0.3; and 4-a-z>0; and wherein at least a portion of the aluminum present in said phosphor is derived from gamma aluminum oxide.

In accordance with yet another aspect, the present invention provides a method of making a phosphor composition. The method includes mixing a gamma aluminum oxide, an oxygen containing compound of strontium, an oxygen containing compound of europium and at least one material selected from the group consisting of lithium tetraborate, lithium carbonate, boric acid, alkali hydroborate, and combinations thereof to form a reaction mixture; heating the reaction mixture in a reducing atmosphere at a temperature in a range from about 800° C. to about 1300° C. for a time sufficient to form the phosphor composition having a formula selected from the group consisting of Sr₄Al₁₄O₂₅:Eu²⁺, Sr_{4-a-z}Aₐ Eu_{z}D₁₂O₂₂ Sr_{4-a-z}AₐEu_{z}D₁₄O₂₅, and combinations thereof; wherein A is an alkaline-earth metal other than strontium; D is aluminum; 0≦a<4; 0.001<z<0.3; and 4-a-z>0; and wherein at least a portion of the aluminum present in the phosphor composition is derived from gamma aluminum oxide.

The phosphor composition described above may be produced using known solid-state reaction methods. In one embodiment, the phosphor precursor composition may be dry or a wet blended and fired in air or under a slightly reducing atmosphere at a temperature in a range from about 800° C. to 1600° C. to afford the phosphor composition. In another embodiment, the phosphor precursor composition may be dry or a wet blended and fired in air or under a slightly reducing atmosphere at a temperature in a range from about 800° C. to 1300° C. to afford the phosphor composition. A fluxing agent (also sometimes referred to as “flux”) may be added to the mixture before or during the step of mixing of the precursor constituents. This flux may be any conventional fluxes, such as a chloride or a fluoride of an alkali/alkaline earth metal. In one embodiment, the flux includes barium chloride, barium fluoride, lithium chloride, lithium fluoride, lithium hydroxide, lithium nitride, lithium tetra borate, aluminum chloride, aluminum fluoride, ammonium chloride, boric acid, magnesium chloride, magnesium fluoride, or any combination of these materials. A quantity of a fluxing agent of less than about 20 percent by weight of the total weight of the mixture is adequate for fluxing purposes. In one embodiment, the fluxing agent less than about 10 percent by weight of the total weight of the mixture is used as flux.

The materials that constitute the phosphor precursor i.e. the gamma alumina, the strontium oxide precursor, the europium oxide precursor, and the at least one rare earth metal oxide precursor may be mixed together by any mechanical method including, but not limited to, stirring or blending in a high-speed blender or a ribbon blender. The materials may be combined and pulverized together in a ball mill, a hammer mill, or a jet mill. The mixing may be carried out by wet milling in alcohol or organic solvents especially when the mixture of the starting materials is to be made into a solution for subsequent precipitation. If the mixture is wet, in one embodiment, the mixture is dried first before being fired under a reducing atmosphere at a temperature from about 900° C. to about 1700° C., preferably from about 1000° C. to about 1600° C., for a time sufficient to convert all the precursor to the phosphor composition.

Typically, the firing may be conducted in a batch wise or continuous process, sometimes with a stirring or mixing action to promote good gas-solid contact. The firing time depends on the quantity of the mixture to be fired, the rate of gas conducted through the firing equipment, and the quality of the gas-solid contact in the firing equipment. Typically, a firing time up to about 10 hours is adequate. The reducing atmosphere typically comprises a reducing gas such as hydrogen, carbon monoxide, or a combination thereof, optionally diluted with an inert gas, such as nitrogen or helium, or a combination thereof. Alternatively, the crucible containing the mixture may be packed in a second closed crucible containing high-purity carbon particles and fired in air so that the carbon particles react with the oxygen present in air, thereby, generating carbon monoxide for providing a reducing atmosphere.

In accordance with another aspect, the present invention provides a lighting apparatus that includes the phosphor of the present invention. In one embodiment, the lighting apparatus includes (i) a source of radiation; and (ii) the phosphor that is radiationally coupled to the source of radiation. As used herein the term “radiationally coupled” means that the elements are associated with each other so radiation from one is transmitted to the other. As discussed in above embodiments, the luminescent material contains a phosphor having a formula selected from the group consisting of Sr_{4-a-z}Aₐ Eu_{z}D₁₂O₂₂ and Sr_{4-a-z}AₐEu_{z}D₁₄O₂₅; wherein A is an at least two alkaline-earth metal other than strontium; D is aluminum; 0≦a<4; 0.001<z<0.3; and 4-a-z>0; and wherein at least a portion of the aluminum present in said phosphor is derived from gamma aluminum oxide.

The luminescence property of a phosphor may be quantified by the conversion yield of the phosphor, which corresponds to a ratio of the number of photons emitted by a phosphor to the number of photons that form the excitation beam. The conversion yield of a phosphor is evaluated by measuring, in the visible range of the electromagnetic spectrum, the emission of a phosphor under an excitation in the UV or VUV range generally at a wavelength below 280 nm. The value of the brightness obtained for the phosphor, at emission intensity integrated between 400 and 700 nm, is then compared with that of a reference phosphor. The phosphor may be used in lighting or display systems having an excitation source in the UV range (200-280 nm), for example around 254 nm.

The phosphor may be placed into the lighting apparatus, such as a fluorescent lamp or any other system where the phosphor is desirable, such as light emitting diode (LED) and a plasma display. The phosphor composition of the present invention may be used in UV excitation devices, such as in trichromatic lamps, especially in mercury vapor trichromatic lamps, lamps for backlighting liquid crystal systems, plasma screens, xenon excitation lamps, devices for excitation by light-emitting diodes (LEDs), fluorescent lamps, cathode ray tube, plasma display device, liquid crystal display (LCD), and UV excitation marking systems. The phosphor composition of the present invention may also be used as a scintillator in an electromagnetic calorimeter, in a gamma ray camera, in a computed tomography scanner or in a laser. These uses are meant to be merely exemplary and not exhaustive.

In one embodiment, the source of radiation and the phosphor are disposed in a sealed housing. In one embodiment, the housing may include any material selected from the group consisting of an epoxy, plastic, low temperature glass, spin-on glass, polymer, thermoplastic, thermoset material, resin, silicone or other type of encapsulating material as is known in the art. Typically, the housing material is transparent or substantially optically transmissive with respect to the wavelength of light produced by the lighting apparatus. The source of radiation may include for example any semiconductor blue or UV light source that is capable of producing white light when its emitted radiation is directed onto the phosphor. In one embodiment, the source of radiation may be a semiconductor laser diode. In another embodiment, the source of radiation may be a mercury gas discharge. In yet another embodiment, the source of radiation is a light-emitting diode.

### EXAMPLES

### Example 1

### (Ex.1): Synthesis of Sr_{3.9}Eu_{0.1}Al₁₄O₂₅ phosphor from gamma alumina

Strontium carbonate (5.7576 gram), europium oxide (0.1760 gram), and gamma alumina (7.1372 gram) were blended together with 0.0309 gram boric acid. The blended mixture was transferred to a furnace and fired at a temperature of about 1300° C. in 1% hydrogen in nitrogen (99%) atmosphere for about 10 hours. At the end of the stipulated time, the sample was cooled and milled to obtain about 11 grams of the product phosphor (Sr_{3.9}Eu_{0.1}Al₁₄O₂₅) having a particle size of approximately 9 microns.

### Comparative Example 1

### (CEx.1): Synthesis of Sr_{3.9}Eu_{0.1}Al₁₄O₂₅ phosphor from alpha alumina

The phosphor composition of CEx.1 was synthesized using the method described above for Example 1, except that alpha alumina (7.1372 gram) was employed instead of gamma alumina.

### Example 2

### (Ex.2): Synthesis of Sr_{3.899}EU_{0.10}Ce_{0.001}Al₁₄O₂₅ (SAE-Ce³⁺)

Strontium carbonate (30.5073 gram), 0.9326 gram of europium oxide, 37.8272 gram of gamma alumina, 0.091 gram of cerium oxide and 0.1638 of gram boric acid were blended together. The blended mixture was transferred to a furnace and fired at a temperature of about 1300° C. in 1% hydrogen in nitrogen (99%) atmosphere for about 10 hours. The sample was cooled and milled to obtain the product phosphor Sr_{3.899}Eu_{0.10}Ce_{0.001}Al₁₄O₂₅ (˜60 grams) having a particle size of approximately about 9 microns.

### Example 3

### (Ex.3): Synthesis of Sr_{3.899}EU_{0.10}Pr_{0.001}Al₁₄O₂₅ (SAE-Pr³⁺)

Strontium Carbonate (30.5073 gram), 0.9326 gram of europium oxide, 37.8272 gram of gamma alumina, and 0.09 gram of praseodymium oxide (Pr₆O₁₁) were blended together with 0.1638 gram of boric acid. The blended mixture was transferred to a furnace and fired at a temperature of about 1300° C. in 1% hydrogen in nitrogen (99%) atmosphere for about 10 hours. The sample was cooled and milled to obtain the product phosphor Sr_{3.899}Eu_{0.10}Pr_{0.001}Al₁₄O₂₅ (˜60 grams) having a particle size of approximately about 9 microns.

### Quantum Efficiency Measurements:

Quantum efficiency and absorption measurements were carried out on the product phosphor powder. The product powder was pressed in an aluminum plaque and a spectra was run using SPEX Flourolog double spectrometer against a known standard.

As shown in Table 1, the quantum efficiency (QE) for the product phosphor derived from gamma alumina (Ex.1) was found to display higher (96) in comparison with the phosphor composition derived from alpha alumina (CEx.1).

TABLE 1

| | ABS | Quantum Efficiency |
|---|---|---|
| Ex. 1 | 86 | 96 |
| CEx. 1 | 83 | 82 |

### Lamp Performance Measurement

The phosphors synthesized were tested in compact and linear fluorescent bulbs (LFL) using established protocols

TABLE 2

| Sample | 100 h | 500 h | 1000 h | 2000 h |
|---|---|---|---|---|
| Ex. 2 | 50.5 | 47.8 | 45.4 | 42.4 |
| Ex. 3 | 51.0 | 49.0 | 47.9 | 46.4 |
| Ex. 1. | 51.9 | 50.2 | 48.8 | 47.1 |
| CEx. 2* | 39.8 | 36.2 | 34.4 | 32.8 |

*CEx. 2 is a commercially available SAE phosphor

Table 2 shows the performance of the phosphor compositions of the present invention in a 9W biax compact fluorescent lamp. As can be seen from Table 2, the phosphor compositions of the present invention show increase performance for a longer duration of time in comparison to the commercially available sample.

Table 3 shows the performance of the phosphor compositions of the present invention in a linear T8 fluorescent lamp. As may be noted from Table 3, the x and y values for the phosphor composition of our present invention is comparable to the x and y value of the commercial phosphor indicating no apparent shift in the color point. However, the phosphor compositions of the present invention display better lamp performance of at least 70 Lumens per Watt in comparison to 44 Lumens per Watt of the commercial sample (CEx.2).

TABLE 3

| | Lumens per | | |
|---|---|---|---|
| Sample | Watt (100 h) | X | Y |
| Ex. 1 | 71.4 | 0.1467 | 0.3548 |
| Ex. 2 | 71.5 | 0.1466 | 0.3547 |
| Ex. 3 | 70.0 | 0.1467 | 0.3544 |
| CEx. 2 | 44 | 0.154 | 0.3566 |

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A phosphor precursor composition comprising: gamma alumina, strontium oxide precursor, europium oxide precursor, and an alkaline earth metal precursor other than strontium oxide precursor which affords a phosphor having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0.

2. The precursor composition according to claim 1, further comprising a rare earth metal oxide.

3. The precursor composition according to claim 2, wherein the rare earth metal oxide is selected from the group consisting of samarium oxide, ytterbium oxide, thulium oxide, cerium oxide, terbium oxide, praseodymium oxide and combinations thereof.

4. The precursor composition according to claim 1, the alkaline earth metal oxide precursor is selected from the group consisting of calcium oxide precursor, barium oxide precursor, magnesium oxide precursor, zinc oxide precursor, and combinations thereof.

5. A phosphor precursor composition comprising: gamma alumina, strontium carbonate, europium oxide, and an alkaline earth metal carbonate other than strontium carbonate which affords a phosphor having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0.

6. A phosphor composition having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0; and wherein at least a portion of the aluminum present in the phosphor composition is derived from gamma aluminum oxide.

7. The composition according to claim 6, further comprising a trivalent rare earth ion.

8. The composition according to claim 7, wherein the trivalent rare earth ion is selected from the group consisting of samarium, ytterbium, thulium, cerium, terbium, praseodymium and combinations thereof.

9. The composition according to claim 7, wherein the trivalent rare earth ion is present in a range from about 10 parts per million to about 10,000 parts per million.

10. The composition according to claim 6, wherein the phosphor has a formula Sr₄Al₁₄O₂₅:Eu²⁺,Q³⁺, wherein Q³⁺ is a trivalent rare earth ion.

11. The composition according to claim 6, wherein A is selected from the group consisting of calcium, barium, magnesium, zinc and combinations thereof.

12. The composition according to claim 6, wherein the amount of europium ion present in a range from about 1 mole % to about 50 mole % of the total weight of the composition.

13. The composition according to claim 6, further comprising a blue-green light emitting phosphor.

14. The composition according to claim 6, further comprising a green light emitting phosphor.

15. A phosphor composition having a formula selected from the group consisting of Sr₄Al₁₄O₂₅:Eu²⁺, Q³⁺, wherein Q³⁺ is a trivalent rare earth ion, and wherein at least a portion of the aluminum present in the phosphor composition is derived from gamma aluminum oxide.

16. A method of making a phosphor composition comprising:
mixing a gamma aluminum oxide, an oxygen containing compound of strontium, an oxygen containing compound of europium and at least one material selected from the group consisting of lithium tetraborate, lithium carbonate, boric acid, borax, alkali borate salts, and combinations thereof to form a reaction mixture;
heating the reaction mixture in a reducing atmosphere at a temperature in a range from about 800° C. to about 1300° C. for a time sufficient to form the phosphor composition having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0; and wherein at least a portion of the aluminum present in the phosphor composition is derived from gamma aluminum oxide.

17. The method according to claim 16, wherein the reaction mixture further comprises at least one rare earth metal oxide.

18. The method according to claim 16, wherein the reaction mixture further comprises at least one halide compound selected from the group consisting of europium, said rare-earth metals, said Group-13 metal, and combinations thereof.

19. A lighting apparatus comprising:
(i) a source of radiation; and
(ii) a phosphor radiationally coupled to the source of radiation, and having a formula selected from the group consisting of Sr₄Al₁₄O₂₅:Eu²⁺, Sr_{4-a-z}AₐEu_{z}Al₁₄O₂₅, and combinations thereof upon thermal treatment at a temperature above 800° C., wherein A is an alkaline earth metal other than strontium, 0≦a<4; 0.001<z<0.3; and 4-a-z>0; and wherein at least a portion of the aluminum present in said phosphor is derived from gamma aluminum oxide.

20. The lighting apparatus according to claim 19, wherein phosphor further comprises a trivalent rare earth ion.

21. The lighting apparatus according to claim 19, wherein the source of radiation is a mercury gas discharge.

22. The lighting apparatus according to claim 19, wherein the source of radiation is a light-emitting diode.

23. The lighting apparatus according to claim 19, wherein the source of radiation and the phosphor composition are disposed in a sealed housing.
